(19) United States
(12) Patent Application Publication
(10) Pub. No.: US 2023/0262046 A1
(43) Pub. Date: Aug. 17, 2023

(54) BUSINESS CONTINUITY APPARATUS

(71) Applicants: Keith GREEN, Dundas (CA); Andy David, Dundas (CA)

(72) Inventors: Keith GREEN, Dundas (CA); Andy David, Dundas (CA)

(21) Appl. No.: 18/108,848

(22) Filed: Feb. 13, 2023

Related U.S. Application Data
(60) Provisional application No. 63/309,872, filed on Feb. 14, 2022.

(51) Int. Cl. H04L 9/40; G06F 11/14

(52) U.S. Cl. CPC H04L 63/0823; H04L 63/0272; G06F 11/1464; G06F 11/1451; H04L 63/108; G06F 2201/84

(57) ABSTRACT

The apparatus is for use with a LAN that has a backup system, an Internet connection and an associated memory storage capacity. The apparatus comprises a computer case, data storage devices and a motherboard. The computer case is adapted to receive data storage devices at least equal in capacity to the LAN. The data storage devices are mounted in the case and have capacity at least equal to that of the LAN. The motherboard has an operating system, a virtualization product, a NAS program and a firewall. The firewall is operatively interposed between the LAN and the Internet connection to protect the LAN from attack. The NAS is configured to be active only during backup operations initiated by task manager components of the virtualization to facilitate a location for the backup of a mirror copy of the data on the LAN by the backup system on the data storage.

### CROSS-REFERENCE TO RELATED APPLICATIONS

This application claims priority to the United States Provisional Patent Application filed Feb. 14, 2022 and assigned Ser. No. 63/309,872; the contents of which are hereby incorporated by reference.

### FIELD

The invention related to the field of computer network security.

### BACKGROUND

Every day many businesses fall prey to network security attacks.

### SUMMARY OF THE INVENTION

A combination of software and hardware in one package/case that includes:
a firewall
a router
a stateful packet filter
a multiport Switch
an expandable Network Access Storage unit
an expandable Onsite storage device
virtualization machine
a server in virtualization
a stand-alone Computer
a stand-alone Server for Linux or MS Windows
a DNS server
an expandable local backup device
a DHCP server
a DMZ for hosting web servers

According to another aspect of the invention, the operating system can be adapted to support multiple NAS.

According to another aspect of the invention, Virtualbox can be configured to contain 2 NAS virtual instance, one being used as a backup device to backup all of the data on the LAN and being inactive during normal operating hours, the second virtual NAS instance being the data working copy.

According to another aspect of the invention the NAS can be configured as a virtual space and in use, can use a full working copy a virtual server in Virtualbox.

According to another aspect of the invention, the apparatus can be configured to provide a redundant DHCP server.

According to another aspect of the invention, the apparatus can be configured to do DNS resolution to allow computers on the network to access each other and the Internet.

According to another aspect of the invention, the apparatus can further comprise multi-port NIC cards and be adapted to act as a switch.

According to another aspect of the invention, the apparatus can be configured to do VLANing to segregate a main network from a WIFI Guest network.

According to another aspect of the invention, the apparatus can be configured to virtualize multiple operating systems to act as a backup domain controller.

According to another aspect of the invention, the apparatus can be configured to do Network Address Translation for getting to the Internet from the LAN.

According to another aspect of the invention, the apparatus can be configured to do DNSL blocking.

According to another aspect of the invention, the apparatus can be configured to do Stateful packet filtering.

According to another aspect of the invention, the apparatus can be configured to do VPN.

According to another aspect of the invention, the apparatus can be used in combination with a UPS and configured to support UPS monitoring.

According to another aspect of the invention, the apparatus can be configured with network diagnostic functionality.

According to another aspect of the invention, the apparatus can be configured with a Remote Authentication Dial-In User Server.

According to another aspect of the invention, the apparatus can be configured to provide certificates and certificate server functions and to isolate from the network computers lacking valid certificates.

According to another aspect of the invention, the apparatus can be configured to throttle Internet access to computers on the network.

According to another aspect of the invention, the apparatus can be configured to act as a time server and ensure that computers on the network have time related connectivity.

Other advantages, features and characteristics of the invention will become evident upon review of the following detailed description with references to the appended drawings, the latter being briefly described hereinafter.

### BRIEF DESCRIPTION OF THE DRAWINGS

In the figures:

FIG. 1 is a view of the housing of the apparatus;

FIG. 2 is a left, top, front view of the structure of FIG. 1, with the left and right-side panels removed;

FIG. 3 is a view of the structure of FIG. 2 with the power supply about to be installed;

FIG. 4 is a view of the structure of FIG. 3 with the power supply installed;

FIG. 5 is a view of the motherboard with the CPU fan, CPU and memory about to be installed;

FIG. 6 is a view of the structure of FIG. 5, fully assembled;

FIG. 7 is a view of the motherboard cover plate about to be installed;

FIG. 8 is a view of the motherboard cover plate fully installed;

FIG. 9 is a view of the box;

FIG. 10 is a view of the motherboard about to be installed in the box;

FIG. 11 shows the motherboard fully installed;

FIG. 12 shows the video adapter about to be installed;

FIG. 13 shows the top panel removed;

FIG. 14A shows the hard drive bracket about to be installed;

FIG. 14B shows a hard drive about to be installed in the bracket;

FIG. 15 shows the fans installed;

FIG. 16 shows the dust panels installed; and

FIG. 17 shows the apparatus in use.

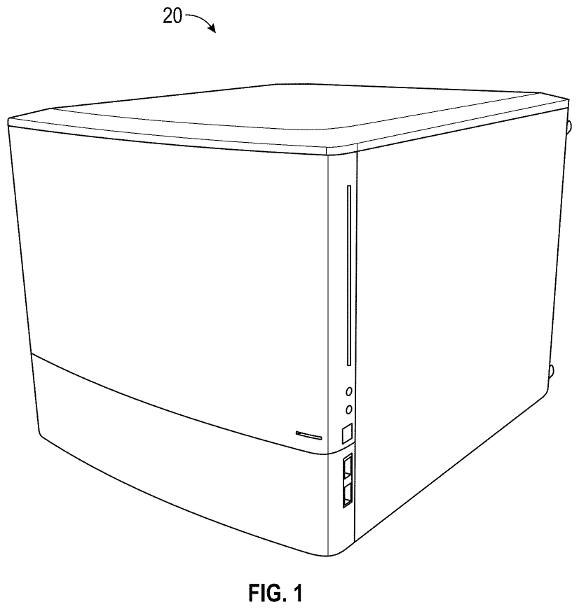

### DETAILED DESCRIPTION OF AN EXAMPLE EMBODIMENT

Components

The example embodiment of the apparatus utilizes the following components:
CPU is 17 8700 3.2 GHz
16 gig RAM DDR 4 Corsair
2 NVME M.2 slots capable of supporting 2 Samsung Pro NVMe hard drives
1×500 gig unit in slot 1
2 PCIe×2
a multi-port Intel based NIC card to support PF Sense® in one slot
2 PCIe×16
Video card in slot 1
[NVIDEA GeForce Gt 730-2 GB GDDR5—902 MHz Core—64-bit Bus Width—PCI Express 2.0—HDMI—VGA—DVI]
4 stock 120 mm Fractal fans that come in the kit
Base air filters—come with the box kit
USB 2 and USB 3 ports are onboard—on the motherboard
6 SATA ports
2.5″ and 3.5″ hard drives in hard drive mounting racks
1 Realtek (brand name) onboard 1 gig NIC
Linux Rocky OS
1-500 gig NVME m.2 drives and
2-4 TB Iron-wolf Seagate drives

### Assembly

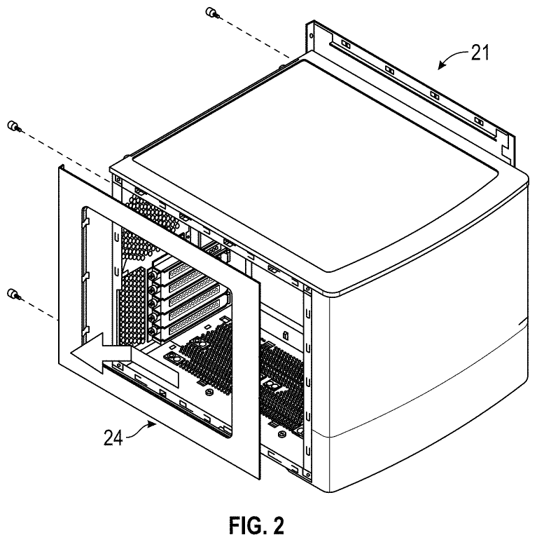

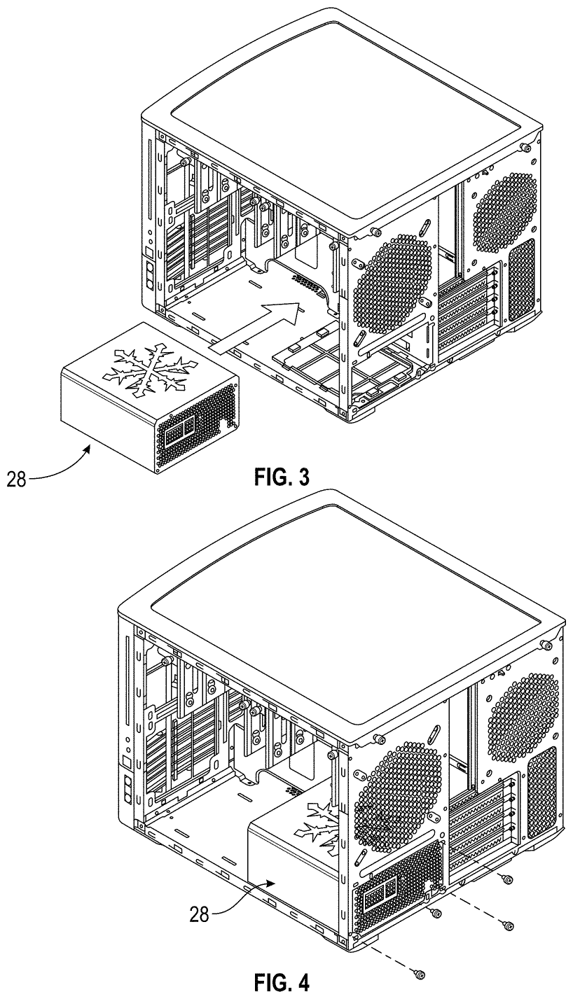

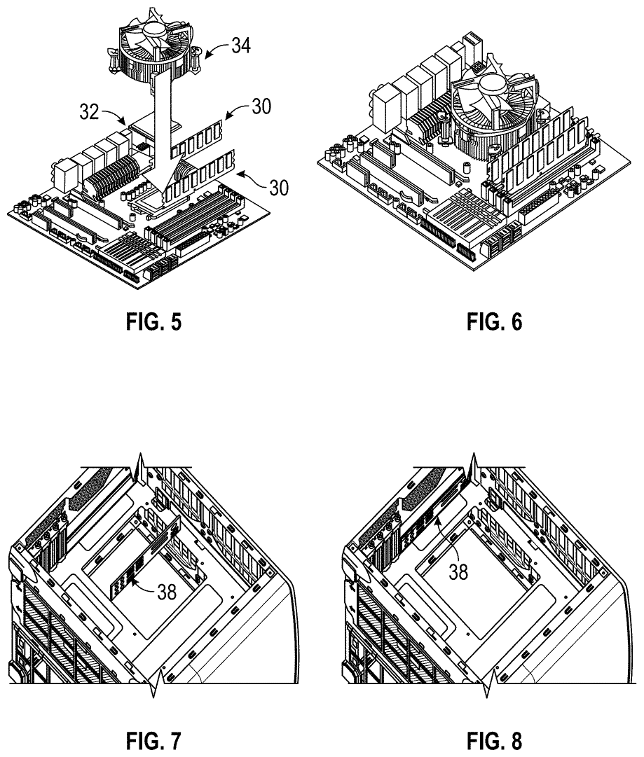

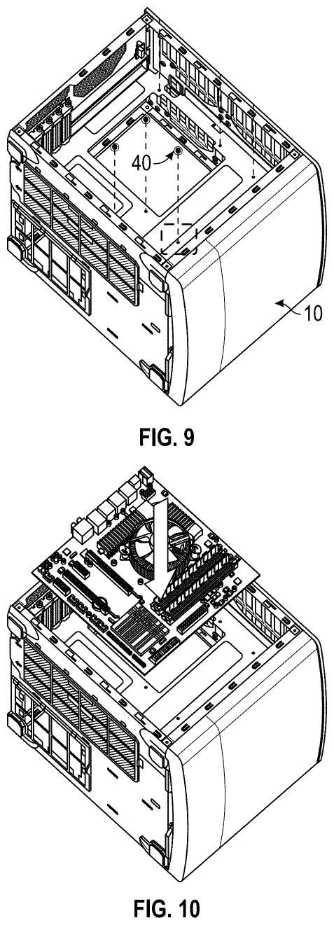

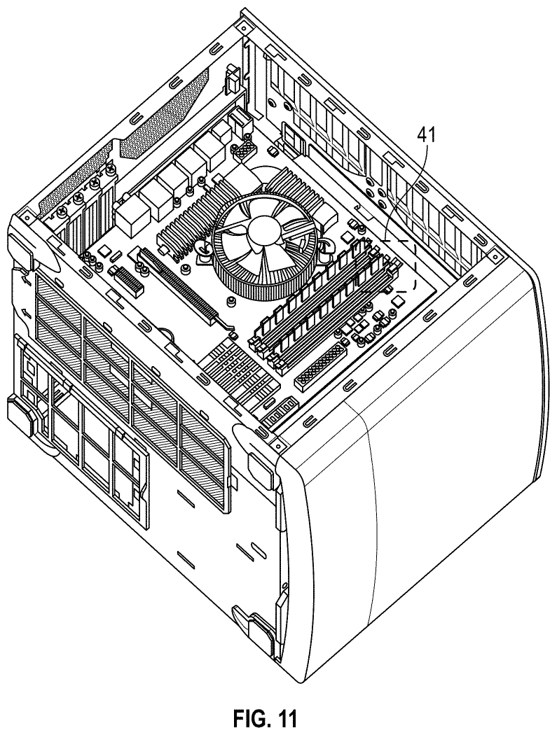

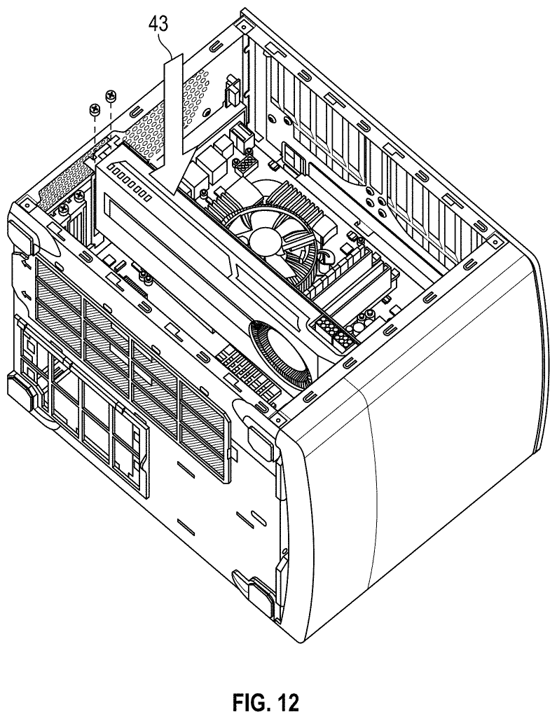

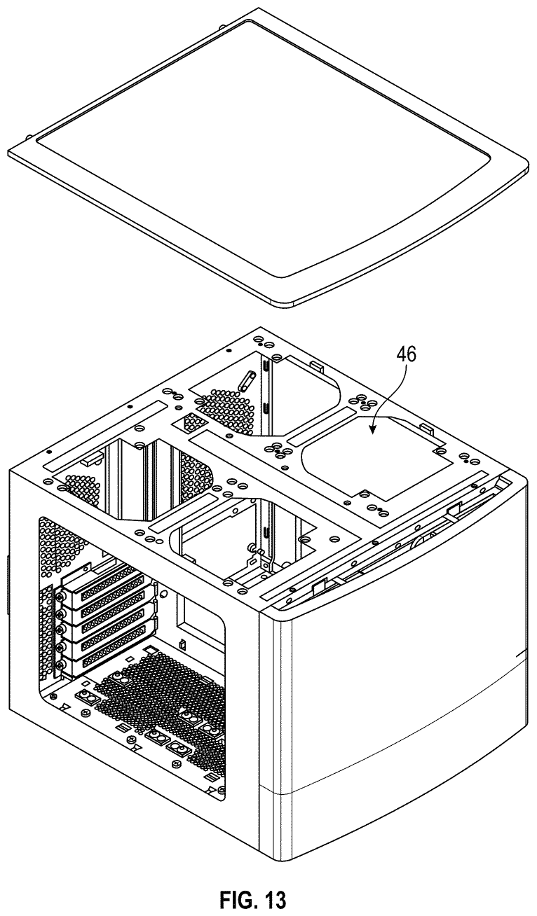

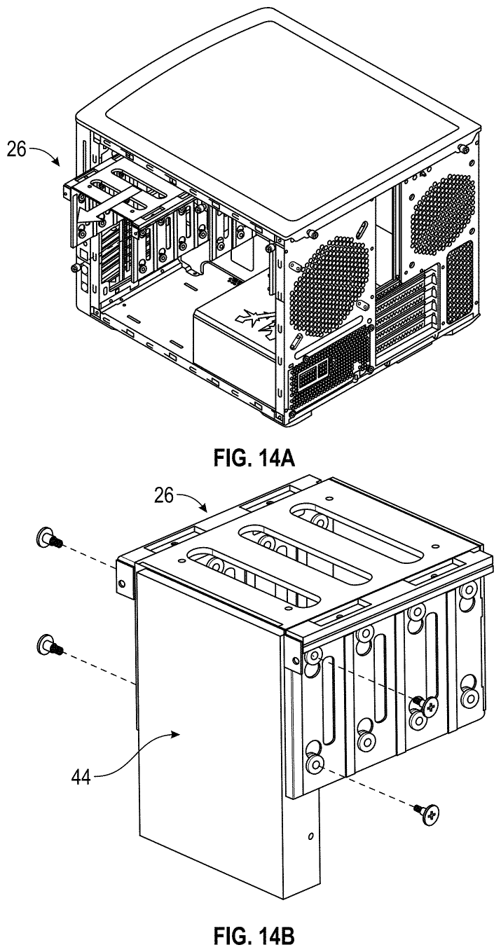

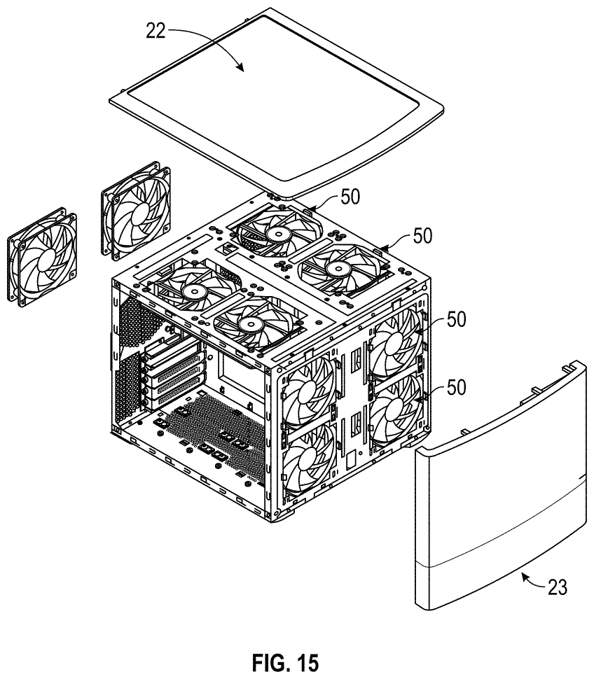

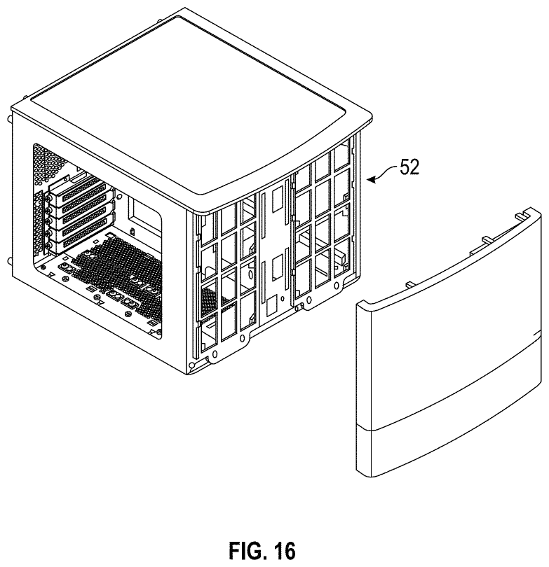

Construction of the apparatus 20 includes the following steps:
removal of left 22 and right 24 panels as indicated in FIG. 2
installation of hard drive bracket 26 in the position shown in FIG. 3; FIG. 2.1 shows a partial view of the bracket pre-installation
installation of power supply 28, as indicated by the sequence of FIGS. 3 and 4
mounting of RAM 30, CPU 32 and CPU fan 34 to motherboard 36 as indicated by the sequence of FIGS. 5 and 6; CPU fan is placed on CPU with heat resistant dielectric grease; CPU is placed on top of CPU slot and clamped down using the motherboard clamps
installation of I/O shield 38, as indicated by the sequence of FIGS. 7, 8
installation of spacer posts 40 for motherboard assembly, as indicated in FIG. 9
mounting of complete motherboard, as indicated by sequence of FIGS. 10, 11, using motherboard screws to fasten motherboard to chassis
installation of graphics card 42 as indicated by FIG. 12
installation of hard drive 44 in hard drive bracket 26 as shown in FIGS. 14A and 14B
removal of top panel 46 and front panel 48 as shown in FIGS. 13 and 15 and installation of cooling fans 50 as shown in FIG. 15; follow the flow chart that comes with the box
installation of filter bracket as indicated in FIG. 16
replacement of panels and insertion of filters and NEC installed in network slot, not shown

### Deployment

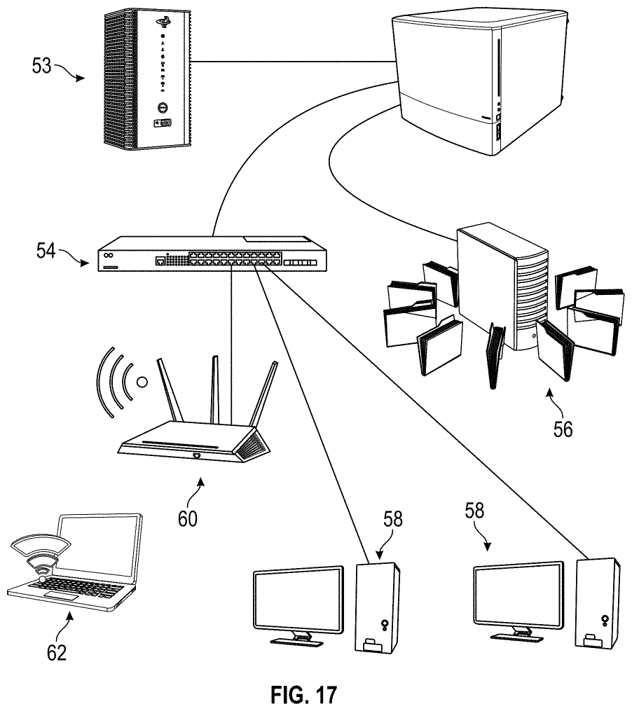

The apparatus is shown in a business IT network in FIG. 17. Herein it will be seen and understood that:
the NEC of the apparatus 20 is coupled to a modem 52, a network switch 54 and via, via VLAN, to a company server 56
computers 58 and a WIFI switch 60 are coupled via wired connection to ports on switch 54
computers 62 are coupled to the network switch via the WIFI switch Configuring the System

### Linux Rocky

Do a search or go to the Linux site and download a copy of Linux Rocky. Do a search and download a copy of Rufus. Rufus is used to create a bootable USB stick to do the install of Rocky. A copy of PFSense is also required and Rufus will be used to do that install as well.

Virtual-box is in the Linux store as is Samba for file sharing.

When the downloads of the ISO files are complete Rufus will be used to created two USB Install sticks, one for Rocky and the other for PFSense.

Create a bootable USB for Rocky using the downloaded Rocky ISO file. To use Rufus to do this you can find the instructions at the following website as of this writing—How to Create a Bootable USB Using Rufus|SoftwareKeep

Using the boot menu keycode combination that came with the motherboard, select boot to USB. Boot to the USB and follow the on screen directions to install Rocky. The instructions can be found at this web site as of the writing of this document—Installing Rocky Linux—Documentation.

After the install do all updates as required.

### Virtualbox™

Go to the Linux Software under the All Apps and select Virtualbox™. Do the install following the on screen instructions. Using Virtualbox™ install an operating system. Instructions on how to use Virtualbox™ are at this website—Oracle® VM VirtualBox®

As this device is now virtualized, install a Server on it that the company can be run from.

### PFSense®

To install PFSense, prep a USB stick with the bootable version of PFSense. Create this bootable USB stick using Rufus using the same procedure that was used to create the Rocky install USB.

Once the USB is created insert the USB with PFSense on it into a USB port. Start Rocky.

### Virtualbox™

To install VirtualBox:
Go to Virtualbox™ and select NEW
Name the instance PFSense.
Select the location for the virtual instance of PFSense
Select Type as BSD
Select Version as BSD 64 bit
Select the memory allocation [4 gig is known to be useful]
Select create virtual hard disk
Select the type of virtualization [VDI is known to be useful]
Select Dynamically allocated
Select the location of the image and the size [80 gig is known to be useful]
Go to storage and choose USB ISO
Start up the image and install PFSense following on screen instructions
Pull out the ISO or USB image before reboot by un-mounting the USB [so that the process does not begin again]
Start-up PFSense and configure it to the network that it will be applied to.

Any configuration questions can be answered by the PFSense documentation located at the following web site—pfSense Documentation|pfSense Documentation (netgate.com)

### TrueNAS®

A Google search for TrueNAS® leads to the download site for the software required for the installation as another virtual machine inside of VirtualBox®. In this construct, a network port is used for the NAS part of the system giving it its own IP address allowing backup programs to locate the place to store the backup files. Employing a good backup program allows the business to do a local backup as well as a cloud backup at the same time then allowing the NAS part of the VM to be shut down to protect the data from infection of potential malware and Ransomware. The install instructions are the same as the procedure for the install of PFSense®.

With this complete, the apparatus is now operable as a small to medium sized business network protection device (firewall) with advanced capabilities. This firewall also provides DHCP and DNS for a network to run on. This will also do stateful packet filtering as well as DNSL blocking using two reliable updatable SHA destination sets for free. The update frequency can be set from daily to weekly to monthly.

### How it Works

The apparatus functions as a business continuity device. It is hooked into the network on the same network segment as the other servers: for a flat network (no VLANS) it is plugged into the network using the switch; for a segmented network (as is best practice) the apparatus is put on the same segment as the servers and NAS (Network Access Storage units).

Once this is done, the daily backup program will run automatically and send a copy of the domains data to the backup virtualized NAS-1 in Virtualbox all the while running the working copy of the companies data on the second virtualized install of NAS-2 in virtual box. Task manager will shut down NAS-1 when the backup is completed. Each NAS instance will have its own IP address and port on a NIC card installed in the apparatus.

The recommended way to use the machine in a flat network is to set up the apparatus, to do a backup that happens after hours. During work hours, the virtualized backup NAS part of the apparatus is shut down for best results.

This can be timed in the Task Manager of the apparatus for startup and then a shut down script into the operating system during work hours. This allows the servers to merge their operational files as servers do amongst each other automatically.

### Other Features of the Example Embodiment and Advantages of Such Features

The OS has Virtualbox installed on it to support multiple NAS instances.

Virtualbox is configured to contain 2 NAS virtual instances, one being used as a backup device to backup all of the data on the LAN and being inactive during normal operating hours, the second NAS being used to support the daily working copy of data.

The NAS is configured as a virtual space and which in use, creates a full working backup copy on the virtual server in Virtualbox.

The example apparatus is configured to provide a redundant DHCP server.

The example apparatus is configured to do DNS resolution to allow computers on the network to access each other and the Internet.

The example apparatus further comprises multi-port NIC cards and adapted to act as a switch.

The example apparatus is configured to do VLANing to segregate a main network from a WIFI

Guest network.

The example apparatus is configured to virtualize multiple operating systems to act as a backup domain controller in a client/server domain environment.

The example apparatus is configured to do Network Address Translation for getting to the Internet from the LAN.

The example apparatus is configured to do DNSL blocking.

The example apparatus is configured to do Stateful packet filtering.

The example apparatus is configured to do VPN.

The example apparatus is combined with an optional UPS and configured to support UPS monitoring.

The example apparatus is configured with network diagnostic functionality.

The example apparatus is configured with a Remote Authentication Dial-In User Server.

The example apparatus is configured to provide certificates and certificate server functions and to isolate from the network computers lacking valid certificates.

The example apparatus is configured to throttle Internet access to computers on the network.

The example apparatus is configured to act as a time server to allow devices on the network to acquire the same time to be able to access network resources.

### Use

There are two recommended methods of use.

In a first method, should the business get attacked by ransomware, it then shuts down all units affected and fires up the apparatus. The tech then maps the clients to the backed up known good files and restarts the client machines so the mapped drives will take then continue running the business.

In a second method, there is a copy of the server in VirtualBox that is part of the domain In this method, the virtualization parts can be shut down and the apparatus can continue to run even if the rest of the network gets infected. [The virtualizations will not be affected as they are not running You cannot infect a file that is not running] Once the virus hits, or the ransomware hits, the business can then follow the above steps, mapping the drives to the new last known good copies of the business information for the business, fire up the server in Virtualbox and the NAS in Virtual box then have the staff restart any uninfected machines and carry on again with minimal down time.

### ADVANTAGES

The apparatus is relatively easy to administer and maintain in comparison to known solutions because it eliminates several separate technologies that one would normally deploy in any IT setup. IE: Computer/Server, Router, Switch, Firewall, and a NAS (Network Access Storage unit).

The apparatus, if equipped with proper hard drive configuration can be used as a network access storage unit or NAS.

If there are only a couple of computers being wired to the device, adding an extra multiport

NIC card or two can eliminate the need for a network switch as well.

The design of the apparatus is such that other solutions are viable, doable and reasonable as well. For instance while the virtualization is of the server and NAS are off, the firewall can be used to protect your business.

In use, the apparatus is all on the same local area network, working at local network speeds rather than Internet speed and throttled backup server speed on the internet in cloud backup which can make the apparatus quite advantageous in comparison to cloud backups that can be quite slow.

Whereas a specific embodiment is described, it will be apparent to persons of ordinary skill in the art that variations are possible. Accordingly, the invention should be understood to be limited only by the accompanying claims, purposively construed.

1. A business continuity apparatus for use with a LAN that has a backup system installed, a connection to the Internet and an associated memory storage capacity, the apparatus comprising:
a computer case adapted to receive data storage devices at least equal in capacity to the LAN;
data storage devices mounted in the case and having capacity at least equal to that of the LAN; and
a motherboard having an operating system, a virtualization product, a NAS program and a firewall, the firewall operatively interposed between the LAN and the Internet connection to protect the LAN from attack, the NAS being configured to be active only during backup operations initiated by task manager components of the virtualization to facilitate a location for the backup of a mirror copy of the data on the LAN by the backup system on the data storage.

2. The apparatus of claim 1, wherein the OS is adapted to support multiple NAS.

3. The apparatus of claim 1, wherein Virtualbox is configured to contain 2 NAS virtual instances, one being used as a backup device to backup all of the data on the LAN and being inactive during normal operating hours, the second NAS being be the data preservation copy.

4. The apparatus of claim 1, wherein the NAS is configured as a virtual space and which in use, creates a full working backup copy on the virtual server in Virtualbox.

5. The apparatus of claim 1, configured to provide a redundant DHCP server.

6. The apparatus of claim 1, configured to do DNS resolution to allow computers on the network to access each other and the Internet.

7. The apparatus of claim 1, further comprising multi-port NIC cards and adapted to act as a switch.

8. The apparatus of claim 6, configured to do VLANing to segregate a main network from a WIFI Guest network.

9. The apparatus of claim 1, configured to virtualize multiple operating systems to act as a backup domain controller.

10. The apparatus of claim 1, configured to do Network Address Translation for getting to the Internet from the LAN.

11. The apparatus of claim 1, configured to do DNSL blocking.

12. The apparatus of claim 1, configured to do Stateful packet filtering.

13. The apparatus of claim 1 configured to do VPN.

14. The apparatus of claim 1 in combination with a UPS and configured to supports UPS monitoring.

15. The apparatus of claim 1, configured with network diagnostic functionality.

16. The apparatus of claim 1, configured with a Remote Authentication Dial-In User Server.

17. The apparatus of claim 1, configured to provide certificates and certificate server functions and to isolate from the network computers lacking valid certificates.

18. The apparatus of claim 1, configured to throttle Internet access to computers on the network.

19. The apparatus of claim 1, configured to act as a time server to allow devices on the network to acquire the same time to be able to access network resources.
